(19) United States
(12) Patent Application Publication
(10) Pub. No.: US 2024/0092559 A1
(43) Pub. Date: Mar. 21, 2024

(54) ASSEMBLY COMPRISING A CAPSULE INTENDED TO RECEIVE A SUBSTANCE FOR THE PREPARATION OF A BEVERAGE AND A SEALING FILM

(71) Applicant: BRAIN CORP SA, Leudelange (LU)

(72) Inventor: Olivier Brivois, Differdange (LU)

(21) Appl. No.: 18/039,423

(22) PCT Filed: Nov. 30, 2021
(86) PCT No.: PCT/EP2021/083648

§ 371 Date: May 30, 2023

(30) Foreign Application Priority Data
Nov. 30, 2020 (LU) LU102246

(51) Int. Cl. B65D 85/804; B65D 65/46; B65D 77/20

(52) U.S. Cl. CPC B65D 85/8043; B65D 65/466; B65D 77/2024; B65D 2203/02; B65D 2565/382; B65D 2565/387

(57) ABSTRACT

An assembly comprising a capsule intended to receive a substance for the preparation of a beverage, the capsule including a body having a lateral wall bordered on either side by a base and by a rim surrounding an opening in the body, the assembly having at least one sealing film covering at least one among the lateral wall, the base and the opening, the sealing film including a layer based on microfibrillated cellulose MFC.

The invention relates to an assembly comprising a capsule intended to receive a substance for the preparation of a beverage and a sealing film.

Capsules with a body that can be manufactured by moulding are known, in particular by injecting a plastic material into a mould provided for this purpose, said body having a lateral wall bordered on either side by a bottom and by a rim surrounding an opening of said body.

Such capsules are in particular intended for preparing a hot beverage of the coffee, tea or infusion type. To do this, a capsule is installed in the housing of a machine provided for this purpose, where it is held by a piston during the passage of an extractor liquid, for example, hot water, through it and the substance it contains.

The capsule must be opened to allow the flow of the beverage through the opening, but the substance must be stored in the capsule with good barrier properties against oxygen and air moisture in order to preserve its organoleptic properties.

To do this, in relation to a compostable capsule, the document WO-2019/185637 provides for the use of a sealing film which can comprise in particular a compostable layer based on cellulose and a layer having barrier properties against oxygen and/or moisture.

The invention aims at improving the prior art by proposing in particular a sealing film of simplified structure combining good oxygen and moisture barrier properties while being able to be advantageously biodegradable and/or compostable.

To this end, the invention proposes an assembly comprising a capsule intended to receive a substance for the preparation of a beverage, said capsule comprising a body having a lateral wall bordered on either side by a bottom and by a rim surrounding an opening of said body, said assembly comprising at least one sealing film covering at least one among the lateral wall, the bottom and the opening, the sealing film comprising a layer based on microfibrillated cellulose MFC.

Other particularities and advantages of the invention will appear in the following description, made with reference to the appended figures, in which:

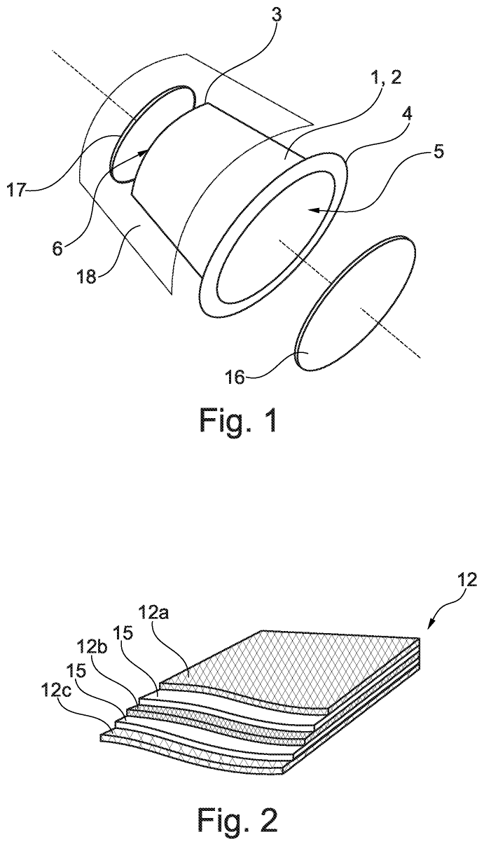

FIG. 1 represents, in exploded perspective, an assembly according to one embodiment of the invention;

FIG. 2 represents, in cutaway perspective, the structure of a sealing film according to one embodiment of the invention.

In relation to these figures, an assembly comprising a capsule 1 intended to receive a substance for the preparation of a beverage is described below.

The capsule 1 comprises a body which can be manufactured by moulding, in particular by injection of a plastic material into a mould, said body having a lateral wall 2 bordered on either side by a bottom 3 and by a rim 4 surrounding an opening 5 of said body.

In relation to FIG. 1, the body of the capsule 1 has a geometry of revolution about a central axis forming a lateral wall 2 which is globally inscribed in a truncated cone with a straight generatrix between the bottom 3 and the upper rim 4.

In relation to a body of a capsule 1 made by moulding a plastic material, the bottom 3 can comprise an opening 6 intended to be covered by a lower film lid 17.

The capsule 1 is also equipped with an upper film lid 16 which is associated with the rim 4 in order to cover the opening 5 by forming, in said body, a loading compartment of the substance.

In particular, the opening 5 allows loading the substance in the compartment closed on the opposite side by the lower film lid 17, said opening being closed by the upper film lid 16 after said loading. Alternatively, after association of the upper film lid 16, the substance can be loaded through the opening 6 of the bottom 3 into the compartment, then the lower film lid 17 can be associated to close said compartment before preparing the beverage.

In particular, the capsule 1 is intended for preparing a hot beverage of the coffee, tea or infusion type. To do this, the capsule 1 can be disposed in the housing of a machine provided for this purpose, in order to be held therein by a piston provided with pins to pierce the bottom 3 of said capsule. Furthermore, the bottom 3 is crossed by at least one spindle to inject extractor liquid, in particular hot water, into the substance contained in the capsule 1.

The injection of the liquid induces an increase of the pressure in the compartment to allow, after breaking the upper film lid 16, the flow of the beverage through the opening 5.

The film lids 16, 17 should allow ensuring a sealed closure of the capsule 1, in particular by forming a barrier against oxygen and moisture, in order to be able to preserve the organoleptic characteristics of the substance stored before the use thereof.

Furthermore, insofar as the material constituting the body of the capsule 1 may not have sufficient performance, the lateral wall 2 may be covered with a label 18 forming a barrier against oxygen and moisture.

To do this, the capsule 1 is equipped with at least one sealing film 12 covering at least one among the lateral wall 2, the bottom 3 and the opening 5 in order to form respectively the label 18, the lower film lid 17 and the upper film lid 16.

Advantageously, the two film lids 16, 17 and the label 18 are formed of the sealing film 12.

The sealing film 12 has at least one layer 12b based on microfibrillated cellulose MFC. Advantageously, the MFC layer 12b can be in the form of a paper layer formed with microfibrillated cellulose so as to be highly fibrillated, while being in particular translucent, so as to be able to be particularly oxygen barrier.

For aesthetic and/or commercial reasons, in particular in relation to the production of the label 18, the MFC layer 12b can be provided with a print made by depositing ink on one of the faces thereof, said print comprising for example information text and/or a decorative element, such as for example a logo, a brand, and/or a description of the substance contained in the capsule 1.

In particular, the MFC layer 12b being transparent, the printing ink can be deposited on the inner face thereof in order to be protected. Furthermore, in order to improve the aesthetic qualities of the capsule 1, the print may have gloss and/or antistatic properties.

The microfibrillated cellulose consists of cellulose microfibrils that are individualised or in the form of aggregates. These microfibrils generally have a diameter of 2 to 20 nanometres, and a length in the range of a few micrometres. The microfibril aggregates are composed of several cellulose microfibrils agglomerated with each other.

The production of MFC is based on the release of the elements constituting the secondary wall of lignocellulosic fibres by mechanical means coupled to enzymatic or chemical pre-treatments. The used fibres can be unbleached or bleached chemical pulp, mechanical pulp produced from wood, recycled pulp . . . .

According to exemplary embodiments, the thickness of the MFC layer 12b is comprised between 30 and 70 μm.

According to exemplary embodiments, the MFC layer 12b has an oxygen transmission rate of at most 5 cm³/m²·day·atm, and in particular less than 1 cm³/m²·day·atm, according to the ASTM D3985 standard and an area density comprised between 40 and 90 g/m².

Furthermore, the MFC layer 12b can have a water vapour transmission rate which is less than 100 g/m²·24 h, measured according to the ASTM E96 standard.

Moreover, the MFC layer 12b may have been treated to improve its resistance to moisture, for example by means of a moisture barrier coating.

According to one embodiment, a water vapour barrier lacquer is applied on the MFC layer 12b to give it a water vapour transmission rate which is less than 50 g/m²·24 h, in particular less than 5 g/m²·24 h and more particularly less than 1 g/m²·24 h.

In particular, the MFC layer 12b allows obtaining a sealing film 12 having a high area density and a sufficient oxygen tightness for the barrier function, and this while being perfectly biodegradable and/or compostable.

Advantageously, the sealing film 12 can be associated with the body 1 during its injection molding of a plastic material, according to an IML process (for In-Mould Labelling). Thus, in particular, a label 18 having a printed MFC layer 12b can be associated by manufacture on the lateral wall 2 of the capsule 1.

Moreover, the sealing film 12 may comprise a sealing layer 12c on the body of the capsule 1, said layer can be adapted to the heat and/or cold sealing.

In relation to FIG. 2 and in particular in relation to the production of the film lids 16, 17, the sealing film 12 has at least one second layer 12a made of fibrous material which is associated on the MFC layer 12b, the layers 12a, 12b each having an area density and an oxygen transmission rate, the area density of the second layer 12a being lower than the area density of the MFC layer 12b, the oxygen transmission rate of the MFC layer 12b being lower than the oxygen transmission rate of the second layer 12a.

The layers 12a, 12b, 12c of the film lid 12 can be associated with each other by a glue film 15. According to one embodiment, a biodegradable adhesive, for example based on corn starch, can be used in order to facilitate the elimination by composting of the waste generated by the capsule 1.

Advantageously, the second layer 12a is based on cellulosic fibres, in particular in the form of a filter-type paper.

This embodiment of the sealing film 12 allows combining an MFC layer 12b having a high area density and a sufficient oxygen tightness for the barrier function, with a second layer 12a of lower area density and without specific barrier function, in which the fragility of an MFC layer 12b of limited thickness can be compensated by the thickness of the second layer 12a.

In relation to the production of the upper film lid 16, the second layer 12a made of filter paper also allows having a function of filtering the beverage extracted through the opening 5 in order to eliminate the substance residues therefrom.

Moreover, the applicant has found that this combination of layers 12a, 12b improved the breakage of the upper film lid 16 for dispensing the beverage, in particular by increasing the stretching of the MFC layer 12b.

Advantageously, the thickness of the second layer 12a is greater than the thickness of the MFC layer 12b. According to exemplary embodiments, the thickness of the second layer 12a is comprised between 60 and 100 μm.

According to exemplary embodiments, the second layer 12a is porous while having an air permeability which is greater than 500 l/m²·s, according to the ISO 9237 standard. The area density of the second layer 12a can be comprised between 10 and 40 g/m², the area density of the film lid 12 possibly being comprised between 100 and 120 g/m².

The invention allows considering a biodegradable and/or compostable upper film lid 12, in particular in combination with a sealing layer 12c based on polylactic acid (PLA) and/or cellulose and glue. Alternatively, the sealing layer 12c can be based on Polyhydroxyalkanoate (PHA) or based on polybutylene succinate (such as BioPBS).

Moreover, in order to facilitate the treatment of waste, the capsule 1 can also be biodegradable and/or compostable, in particular having a body made from a compostable material according to the EN 13432 standard, as for example described in the document WO-2019/185637.

In particular, the materials constituting the capsule 1 and the sealing film 12 can be chosen to allow both industrial and domestic composting, and can be biodegradable. Advantageously, the body of the capsule 1 is produced by injection of a plastic material based on polylactic acid (PLA) or Polyhydroxyalkanoate (PHA), insofar as these materials, in addition to being compostable and compatible with food substances, allow easily producing by injection capsules 1 with thin walls, and which do not deform under the effect of heat.

In relation to such a capsule 1, four exemplary embodiments of the sealing film 12 are described below.

### EXAMPLE 1

Second layer 12a: filter paper; area density 20-23 g/m²; thickness 65-85 μm; air permeability greater than 950 l/m²·s;
Internal layer 12b: MFC paper; area density 60-65 g/m²; thickness 50-60 μm; oxygen transmission rate less than 0.2 cm³/m²·day·atm; water vapour transmission rate 70-80 g/m²·24 h;
Sealing layer 12c: PLA; area density 15-25 g/m²; thickness 150-250 μm.

The sealing film 12 according to this example has a weight in the range of 112 g and can be industrially compostable.

### EXAMPLE 2

Second layer 12a: filter paper; area density 20-23 g/m²; thickness 65-85 μm; air permeability greater than 950 l/m²·s;
Internal layer 12b: MFC paper; area density 60-65 g/m²; thickness 50-60 μm; oxygen transmission rate less than 0.2 cm³/m²·day·atm; on which a water vapour barrier lacquer has been applied to give it a water vapour transmission rate of less than 5 g/m²·24 h;
Sealing layer 12c: PLA; area density 15-25 g/m²; thickness 150-250 μm.

The sealing film 12 according to this example has a weight in the range of 112 g and can be industrially compostable.

### EXAMPLE 3

Second layer 12a: filter paper; area density 25-30 g/m²; thickness 80-100 μm; air permeability greater than 950 l/m²·s;
Internal layer 12b: MFC paper; area density 60-65 g/m²; thickness 50-60 μm; oxygen transmission rate less than 0.2 cm³/m²·day·atm; water vapour transmission rate 70-80 g/m²·24 h;
Sealing layer 12c: PLA; area density 15-25 g/m²; thickness 150-250 μm.

The sealing film 12 according to this example has a weight in the range of 116 g and can be industrially compostable.

### EXAMPLE 4

Second layer 12a: filter paper; area density 20-23 g/m²; thickness 65-85 μm; air permeability greater than 950 l/m²·s;
Internal layer 12b: MFC paper; area density 60-65 g/m²; thickness 50-60 μm; oxygen transmission rate less than 0.2 cm³/m²·day·atm; water vapour transmission rate 70-80 g/m²·24 h;
Sealing layer 12c: filter paper; area density 10-15 g/m²; thickness 40-50 μm.

The sealing film 12 according to this example has a weight in the range of 110 g and can be domestically compostable.

In other exemplary embodiments, the sealing film 12 may comprise only one layer 12b based on microfibrillated cellulose MFC, for example as provided in Examples 1 to 4 above, associated with a sealing layer 12c to form a two-layer film 12 or with a sealant lacquer to form a single-layer film 12.

1. An assembly comprising a capsule provided to receive a substance for the preparation of a beverage, said capsule comprising a body having a lateral wall bordered on either side by a bottom and by a rim surrounding an opening (5) of said body, said assembly comprising at least one sealing film covering at least one among the lateral wall, the base and the opening, the sealing film comprising a layer based on microfibrillated cellulose MFC.

2. The assembly according to claim 1, the oxygen transmission rate of the MFC layer being at most 5 cm³/m²·day·atm, according to the ASTM D3985 standard to form a sealing layer.

3. The assembly according to claim 1, the MFC layer having a water vapour transmission rate which is less than 5 g/m²·24 h, measured according to the ASTM E96 standard.

4. The assembly according to claim 3, the MFC layer having been treated to improve its moisture resistance.

5. The assembly according to claim 1, the area density of the MFC layer being between and 90 g/m².

6. The assembly according to claim 1, the thickness of the MFC layer being between 30 and 70 μm.

7. The assembly according to claim 1, the sealing film including a sealing layer.

8. The assembly according to claim 1, at least one of the body of the capsule and the sealing film being at least one of a group including biodegradable and compostable.

9. The assembly according to claim 1, the sealing film having at least one second layer made of fibrous material which is associated on the MFC layer, the layers each having an area density and an oxygen transmission rate, the area density of the second layer being less than the area density of the MFC layer, the oxygen transmission rate of the MFC layer being lower than the oxygen transmission rate of the second layer.

10. The assembly according to claim 9, the second layer being based on a filter-type paper.

11. The assembly according to claim 1, further comprising an upper film lid provided to be associated with the rim in order to cover the opening, said upper film lid being formed of the sealing film.

12. The assembly according to claim 1, further comprising a lower film lid provided to be associated with the bottom in order to cover an opening (6) formed in said bottom, said lower film lid being formed of the sealing film.

13. The assembly according to claim 1, further comprising a label provided to be associated with the body of the capsule in order to cover the lateral wall, said label being formed of the sealing film.

14. The assembly according to claim 1, the body of the capsule being formed by moulding a plastic material, the sealing film being associated with said body during said moulding using an IML process.
